(19) United States
(12) Patent Application Publication
(10) Pub. No.: US 2020/0139634 A1
(43) Pub. Date: May 7, 2020

(54) FDM PRINTER AND METHOD WITH FORCE FEEDBACK FOR PRINTING NON-UNIFORM FILAMENTS

(71) Applicant: SIGNIFY HOLDING B.V., EINDHOVEN (NL)

(72) Inventors: RIFAT ATA MUSTAFA HIKMET, EINDHOVEN (NL); JACOBUS PETRUS JOHANNES VAN OS, EINDHOVEN (NL)

(21) Appl. No.: 16/615,906

(22) PCT Filed: May 18, 2018
(86) PCT No.: PCT/EP2018/063157

§ 371 Date: Nov. 22, 2019

(30) Foreign Application Priority Data
May 30, 2017 (EP) 17173394.2

(51) Int. Cl. B29C 64/393; B29C 64/118; B29C 64/209; B33Y 10/00; B33Y 30/00; B33Y 50/02

(52) U.S. Cl. CPC B29C 64/393; B29C 64/118; B33Y 50/02; B33Y 10/00; B33Y 30/00; B29C 64/209

(57) ABSTRACT

The invention provides a method for 3D printing a 3D item (1), the method comprising providing 3D printable material (201) to a printer nozzle (502), using force for expelling the 3D printable material through the printer nozzle (502), and depositing during a printing stage a filament (320) comprising 3D printable material (201) via the printer nozzle (502), to provide the 3D item (1) comprising 3D printed material (202), wherein the method further comprising sensing a force-related parameter for controlling extrusion rate of the 3D printable material (201).

### FIELD OF THE INVENTION

The invention relates to a method for manufacturing a 3D (printed) item by means of fused deposition modeling. The invention also relates to the 3D (printed) item, such as obtainable with such method. Further, the invention relates to a 3D printer that can be used for such method.

### BACKGROUND OF THE INVENTION

Additive manufacturing, such as fused deposition modelling printing, is known in the art. US2015266235, for instance, describes a system including a first system configured and arranged to combine at least two different input materials; a controller coupled with the first system and configured to independently control a feed rate for each of the different input materials into the first system to generate a processed material that varies in composition along its length; and a second system configured and arranged to add syncing features to the processed material. The syncing features are useable by a material deposition system to synchronize the variation in composition of the processed material during additive manufacturing of an object using the processed material. The controller can configured to create data usable by the material deposition system to sync the processed material with locations of the object during additive manufacturing. Further, the second system can include a material shaping system, and the syncing features can include shapes added to the processed material. Further, this document also describes that the deposition rate (volume of material deposited per linear distance moved by a material deposition device) changes along the filament length as it is created in order to achieve the varying filament thickness needed to match the varying thickness of the layers while keeping the width constant. Alternatively, the width of the filaments could be varied while keeping the material deposition rate constant in order to achieve a desired layer thickness. In some cases, both the width and material deposition rate can be varied along the length of the filament.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals and polymers. 3D printing can also be used in producing molds which can then be used for replicating objects.

For the purpose of making molds, the use of polyjet technique has been suggested. This technique makes use of layer by layer deposition of photo-polymerisable material which is cured after each deposition to form a solid structure. While this technique produces smooth surfaces the photo curable materials are not very stable and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast and can be used for printing complicated object. Such printers are used in printing various shapes using various polymers. The technique is also being further developed in the production of LED luminaires and lighting solutions.

In these FDM printers the filament is fed at a constant speed to the nozzle. Therefore in order to obtain a constant rate of material flow out of the nozzle it is necessary to use a filament with a constant diameter. Creating filaments with an essentially constant diameter is relatively elaborate and leads to high prizes of the filaments. Furthermore, even though optimized on their properties, the currently available filament diameters appear to have a tolerance of about 1.3%. This often also leads to visual defects in printed objects which are not desirable. Hence, ribbed structures are provided with uneven heights or widths of the ribs, which for several reasons may be less desirable.

Hence, it is an aspect of the invention to provide an alternative 3D printing method and/or 3D (printed) item which preferably further at least partly obviate(s) one or more of above-described drawbacks. It is further an aspect of the invention to provide an alternative 3D printer which preferably further at least partly obviate(s) one or more of above-described drawbacks. The present invention may have as object to overcome or ameliorate at least one of the disadvantages of the prior art and/or to provide a useful alternative.

Herein, in order to be able to use filaments without a constant cross-section area we suggest amongst other solutions using a feeder system with a capillary and a force measuring unit where the force used for feeding the filament is—in embodiments—kept constant as the filament is fed into the nozzle. In this way, the flow rate coming of the FDM printer nozzle can be kept constant during the use of filaments with non-uniform cross-section. Hence, amongst others, herein we suggest a method where we measure the force applied onto the filament and keep it constant during the printing process rather than feeding the filament at a constant speed.

The volumetric flow rate Q of a polymer with a viscosity of ηpushed through a capillary with a radius of r and length of L is related to the pressure drop which is in return related to the force F according to the following equation:

$$Q = \frac{P π {r}^{4}}{8 η L} = \frac{{Fr}^{2}}{8 η L}$$

For this purpose, the filament may in embodiments be fed through a capillary. Aiming at e.g. 110 cm³/h (3.05 10⁻⁸ m³/s) flow rate of using a capillary 3.85 mm in diameter and 5 mm long and a polymer with a viscosity of 5K Pa·s one needs to use 3 Newton force. If the diameter tolerance is 0.05 mm then it means that at a constant feeder speed the flow rate fluctuates between 3.15 10⁻⁸ m³ and 2.94 10⁻⁸ m³ as the filament diameter fluctuates leading to uniformities in the print. Without the force feedback to keep the force constant the force varies between 2.895 Nt when the diameter is 3.9 mm thick and 3.1 Newton when the diameter is 3.8 mm.

Hence, in a first aspect the invention provides a method for 3D printing a 3D item (herein also indicated as “item” or “3D printed item”) by means of fused deposition modeling using a fused deposition modeling 3D printer that comprises a liquefier or a heater configured to heat a 3D printable thermoplastic polymer material upstream of a printer nozzle, the method comprising providing the 3D printable thermoplastic polymer material to the printer nozzle (“nozzle”), the 3D printable thermoplastic polymer material having a glass transition temperature (Tg) and/or a melting point (Tm), heating the 3D printable thermoplastic polymer material to a temperature of at least the glass transition temperature (Tg) or at least the melting temperature (Tm) of the 3D printable thermoplastic polymer material using the liquefier or the heater, using force for expelling the 3D printable thermoplastic polymer material through the printer nozzle, and depositing during a printing stage a filament comprising 3D printable thermoplastic polymer material via the printer nozzle, to provide the 3D item comprising 3D printed thermoplastic polymer material, wherein the method further comprising sensing a force-related parameter by a sensor for controlling extrusion rate of the 3D printable thermoplastic polymer material (from the printer nozzle), wherein the sensor is arranged to sense the force-related parameter at a position upstream of the liquefier or the heater.

Instead of the term “extrusion rate” also the term “flow rate” may be used. It especially refers to the rate with which the filament escapes from the printer nozzle. The term “extrusion rate especially relates to the mass per unit time, herein especially the rate of the 3D printable material with which it is expelled from the printer nozzle. Such a method and such a 3D printer (see further also below) may enable the use of filaments coming from polymer manufacturers without pelletizing them. It also enables FDM printers to produce objects with a reduced number of defects. Further, such method (and 3D printer) may allow a highly controlled thickness or diameter of the filaments escaping from the printer nozzle. This may be used to produce layers having relatively identical dimensions, but this may also be used to control the dimensions with a higher precision. Sensing can be done with a sensor. The sensor can be functionally coupled to a control system. The control system can control the force for expelling the 3D printable material through the printer nozzle. In this way, a feedback loop may be provided, which can be used to control the filament diameter of the filament expelled from the nozzle, such as for keeping the extrusion rate constant. Therefore, the invention provides an FDM printer and method with force feedback for a controlled printing based on non-uniform filaments as input material. Especially, the method is a single-filament method, i.e. a single filament is guided to the printer head, and not two or more filaments.

As indicated above, the invention provides a method for 3D printing a 3D item by means of fused deposition modeling using a fused deposition modeling 3D printer that comprises a liquefier or a heater configured to heat a 3D printable thermoplastic polymer material upstream of a printer nozzle, the method comprising providing the 3D printable thermoplastic polymer material to the printer nozzle. A 3D printing stage unit comprises the printer head and the printer nozzle. The 3D printable thermoplastic polymer material has a glass transition temperature (Tg) and/or a melting point (Tm). The 3D printable thermoplastic polymer material is heated to a temperature of at least the glass transition temperature (Tg) or at least the melting temperature (Tm) of the 3D printable thermoplastic polymer material using the liquefier or the heater. The 3D printable material leaves the nozzle as filament and is deposited on a support (or on earlier 3D printed material on the support). Hence, the 3D printable material may be directly deposited on the support, or may be deposited indirectly on the support, when it is deposited on already 3D printed material on the support. The 3D printable material deposited on the support is indicated as 3D printed material, or as item (comprising 3D printed material); see also below. During a printing stage of the method, a filament comprising 3D printable material is deposited via the printer nozzle. In this way, the 3D item comprising 3D printed material is provided.

The 3D printable material can be provided as filament to the printer head or may be provided as particulate material. In the latter embodiment, an additional extruder may convert the particulate material to the filament. Hence, the 3D printable material may be provided as filament or as particulate material, but is in both embodiments printed (“extruded”) as filament.

Further, optionally the 3D printable material is provided as filament, but processed into particulate material, which processed material is again converted into the additional extruder to the filament for the printer head. This may especially be useful when filaments are used with very irregular diameter. The thus obtained filament may have a better controlled diameter, though even in these instances the diameter may vary more than desired.

Hence, the 3D printable material is provided as filament to the printer head. With the invention it is possible in all afore-mentioned options to better control filament thickness or diameter. This may allow the use of filaments, even with a sub-optimal constant thickness as with the method and 3D printer as defined herein, differences in diameter can be handled. With the invention, if desired, it may be possible to keep the extrusion rate or printing of the 3D printable material essentially constant, or control better. Therefore, the invention provides controlling the extrusion rate of the 3D printable material. In other words, the rate with which the filament leaves the printer nozzles is controlled by controlling the force used to expel the 3D printable thermoplastic polymer material from the nozzle.

In all afore mentioned option, force is used for expelling the 3D printable thermoplastic polymer material through the printer nozzle. When a filament is used that is directly printed, then force is used to transport the filament through the printer head, for instance with a motor. In other embodiments, force may be used to press the particulate 3D printable material through the printer nozzle for providing the filament. Pressure may be used to extrude the 3D printable material to provide the filament.

During the feeding of the filament at a constant speed the registered force will show a dependence on the thickness of the input diameter of the filament as it gets melted and become extruded through the printer head. Further, the rate at which the polymer is extruded through the nozzle will also depend on this force. Therefore, the force applied may be a better parameter than e.g. rate at which the polymer filament fed into the extruder to obtain a constant extrusion rate. Hence, the method further comprises sensing a force-related parameter by a sensor for controlling extrusion of the 3D printable thermoplastic polymer material from the printer nozzle. The sensor is arranged to sense the force-related parameter at a position upstream of the liquefier or the heater.

Therefore, in specific embodiments the method comprises sensing the force-related parameter for controlling extrusion rate of the filament. Here, the term “controlling” may especially refer to keep the flow rate on the desired predetermined value (see further also below). This diameter may change over time for specific purposes, associated with the design of the 3D item. In specific embodiments, it may be desired to have a constant thickness of the 3D printed filaments, for instance when printing walls etcetera. Hence, in specific embodiments the method may comprise sensing the force-related parameter for maintaining a flow rate of the filament constant during at least part of the printing stage. The force may be sensed in several ways and/or at several positions (stages) within the 3D printer (printing process), of which one or more may be chosen.

In embodiments, the fused deposition modeling 3D printer may comprise a 3D printing stage unit which comprises a printer head and the printer nozzle. The 3D printable thermoplastic polymer material is provided by an applicator via a transport channel or a guiding tube to the liquefier or the heater and then to the printer nozzle. The sensor may be applied at at least one of the following positions: (i) at the applicator, (ii) at the transport channel or guiding tube, (iii) at a flexible coupling element arranged between the printer nozzle and the printer head, wherein the printer nozzle is movably associated with the printer head, (iv) at the outside of the 3D printing stage unit. Outside of the 3D printing stage unit means that the sensor measures at the 3D printing stage unit, but not in the melt state of the 3D printable thermoplastic polymer material. For example, a sensor may measure a force-related parameter on the outside of the printer head. For example, a sensor may measure a force-related parameter on the outside of a holding means which mechanically holds the printer head.

In embodiments, an applicator, such as a motor, may be applied to force the filament through the 3D printer, such as through a capillary (see also below) or through the printer nozzle. The torque necessary to rotate a rotating element for transporting the filament may be sensed and controlled. In this way, the flow rate may be kept constant.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc., Beyond that, the term “controlling” and similar terms may additionally include monitoring. Hence, the term “controlling” and similar terms may include imposing behavior on an element and also imposing behavior on an element and monitoring the element. Therefore, in embodiments the method comprises providing with an applicator (configured to provide the filament to the printer nozzle) the filament to the printer nozzle, wherein the applicator comprises a rotational element for transporting the filament, and wherein the method comprises controlling a torque on the rotational element. Hence, the method may comprise controlling a torque applied by the rotational element for controlling the extrusion rate of the 3D printable material. By applying the torque, both the flow rate can be controlled but also (implicitly) the force-related parameter is sensed.

Alternatively or additionally, the method may comprise transporting the filament through a transport channel, wherein the transport channel comprises an upstream part and a downstream part which are associated to each other via a pressure sensor for sensing the force-related parameter for controlling extrusion of the 3D printable material. The larger the force, the larger the distance between the two parts may be. Hence, the distance between the two parts may be used as measure for the force. The distance between the two parts may be small and the difference in distances may also be small; for instance, the default distance may be in the range of 0-2000 μm, the distance difference due to differences in forces may e.g. (also) be in the range of 0-2000 μm, with 0 μm indicating no force at all, and 2000 μm may be a maximum realistic force. Hence, the distance in such embodiments may be a force-related parameter.

Further, the two parts may be coupled to each other via a flexible coupling element, allowing some translation along an axis of transportation of one part relative to the other. In specific embodiments, the downstream part comprises the printer nozzle. Hence, the printer nozzle may be configured such that it is configured essentially independent from the printer head, and movable associated with the printer head. The sensor may comprise the flexible coupling element.

In further specific embodiments, a transport channel may be applied wherein part of the channel comprises a relatively flexible part. During operation, the transport channel maintains its diameter at processing pressure parameters. However, the flexible part may, dependent upon the pressure the flexible part may bulge more or less. This may be measured with a pressure sensor by which the force can be measured. Also in this way a force-related parameter can be sensed.

Alternatively or additionally, the printer nozzle comprises a printer nozzle wall along which the 3D-printable material is guided, and wherein the printer nozzle wall may comprise a pressure sensor for sensing the force-related parameter for controlling extrusion of the 3D printable material. When the 3D printable material is pressed through the nozzle, the pressure sensor will experience a force. Also in this way a force-related parameter can be sensed.

In yet further embodiments, one may use a sensor configured to measure strain in the transport channel. When the transport channel is made of an elastic material force will apply on it during the transportation of the filament. The force will lead to a small deformation (strain) which can be measured. When the strain is sensed, and maintained constant the force will also kept constant.

Hence, as indicated above the method may comprise providing particulate 3D printable material and processing the particulate 3D printable material into the filament, for further processing in the printer head.

In any case, by pressing the 3D printable material through the nozzle and while heating the 3D printable material in the nozzle, the filament may be formed to its final thickness or diameter, expelled from the nozzle and deposited. The temperature in the nozzle may be higher than the glass temperature and/or the melting temperature (see also below).

Any force sensed, or other parameters related thereto, such as torque, or energy consumption of the applicator, etc., may reflect the force with which the 3D printable material is expelled from the nozzle. Hence, herein the term “force-related parameter” is applied. A pressure sensor may be used to measure the force-related parameter. Hence, herein the term “force sensor” or “pressure sensor” are used. Therefore, a sensor for sensing the force-related parameter may be a force sensor or pressure sensor. Alternatively or additionally, a sensor selected from the group consisting of a calibrated force sensor, a torque sensor, a piezo electric sensor, a capacitive sensor, a resistance sensor, etc. may be applied.

As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. The 3D printable material is printed as a filament and deposited as such. The 3D printable material may be provided as filament or may be formed into a filament. Hence, whatever starting materials are applied, a filament comprising 3D printable material is provided by the printer head and 3D printed.

Herein, the term “3D printable material” may also be indicated as “printable material. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action comprises heating the 3D printable material above the glass transition and if it is a semi-crystalline polymer above the melting temperature. In yet another embodiment, the 3D printable material comprises a (thermoplastic) polymer having a melting point (Tₘ), and the printer head action comprises heating the 3D printable material to be deposited on the receiver item to a temperature of at least the melting point. The glass transition temperature is in general not the same thing as the melting temperature. Melting is a transition which occurs in crystalline polymers. Melting happens when the polymer chains fall out of their crystal structures, and become a disordered liquid. The glass transition is a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former.

As indicated above, the invention thus provides a method comprising providing a filament of 3D printable material and printing during a printing stage said 3D printable material on a substrate, to provide said 3D item. Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polystyrene (PS), PE (such as expanded-high impact-Polythene (or polyethene), Low density (LDPE) High density (HDPE)), PVC (polyvinyl chloride) Polychloroethene, etc. Optionally, the 3D printable material comprises a 3D printable material selected from the group consisting of Urea formaldehyde, Polyester resin, Epoxy resin, Melamine formaldehyde, Polycarbonate (PC), thermoplastic elastomer, etc. Optionally, the 3D printable material comprises a 3D printable material selected from the group consisting of a polysulfone.

The printable material is printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Further, the invention relates to a software product that can be used to execute the method described herein.

The herein described method provides 3D printed items. Hence, the invention also provides in a further aspect a 3D printed item obtainable with the herein described method. Especially, the invention provides a 3D printed item comprising 3D printed material, the 3D printed item comprising a ribbed structure comprising ridges and valleys defining height differences (Δh) between adjacent ridges and valleys, wherein an average difference from an average height difference Δh_{avg} is equal to or less than 2%, such as equal to or less than 1%. The ribbed structure is essentially inherent to FDM printing. However, due to irregularities in the filament, a direct use of the filament may lead to additional features, such as differences in height between the ribs. With the present invention, such differences may be minimized.

The (with the herein described method) obtained 3D printed item may be functional per se. For instance, the 3D printed item may be a lens, a collimator, a reflector, etc. The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light source (like a LED), etc. The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. Alternatively, or additionally, the functional component may comprise a thermal component (e.g. configured to cool or to heat an electrical component). Hence, the functional component may be configured to generate heat or to scavenge heat, etc.

Returning to the 3D printing process, a specific 3D printer may be used to provide the 3D printed item described herein. Therefore, in yet a further aspect the invention also provides a fused deposition modeling 3D printer (“printer” or “3D printer”), comprising (a) a printer head comprising a printer nozzle, and (b) a 3D printable material providing device configured to provide 3D printable material to the printer head, wherein the fused deposition modeling 3D printer is configured to deposit during a printing stage a filament comprising 3D printable material via the printer nozzle using force for expelling the 3D printable material through the printer nozzle (to a substrate), and wherein the fused deposition modeling 3D printer further comprises (c) a pressure sensor configured for sensing a force-related parameter for controlling extrusion, especially an extrusion rate, of the 3D printable material. The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to deposit during a printing stage a filament comprising 3D printable material via the printer nozzle using force for expelling the 3D printable material through the printer nozzle (to a substrate), and especially, the fused deposition modeling 3D printer further comprises (c) a pressure sensor configured for sensing a force-related parameter for controlling extrusion of the 3D printable material.

The pressure or force sensor may be any sensor for measuring a pressure in a channel, a pressure between two channel parts, a pressure on a flexible part, etc. etc. Especially, the sensor may be configured to sense forces in the range of 0.1-20 N, such as 0.1-10 Newton.

Some embodiments of the printer have in fact already been described above in relation to the method. Some of these embodiments described above are for the sake of completeness also reiterated below.

In specific embodiments, the fused deposition modeling 3D printer further comprises an applicator, especially configured to provide the filament to the printer nozzle, wherein the applicator may especially comprise a rotational element for transporting the filament, and wherein the method comprises controlling a torque on the rotational element.

As indicated above, in further embodiments the fused deposition modeling 3D printer may further comprise a transport channel, wherein the fused deposition modeling 3D printer is configured to transport the filament through the transport channel, wherein the transport channel comprises an upstream part and a downstream part which are associated to each other via a pressure sensor for sensing the force-related parameter for controlling extrusion of the 3D printable material. For instance, in embodiments the downstream part comprises the printer nozzle.

As indicated above, in specific embodiments of the fused deposition modeling 3D printer the printer nozzle may comprise a printer nozzle wall along which the filament is to be guided, and wherein the printer nozzle wall comprises a pressure sensor for sensing the force-related parameter for controlling extrusion of the 3D printable material.

As indicated above, the 3D printable material providing device may provide a filament to the printer head either based on particulate material processed into the filament, or based on a filament as such. Therefore, in embodiments of the fused deposition modeling 3D printer, the 3D printable material providing device is configured to provide particulate 3D printable material to the 3D printer, wherein the 3D printer further comprises an (additional) extruder for processing the 3D printable material into the filament (for introduction into the printer head).

In specific embodiments, the fused deposition modeling 3D printer may be configured to maintain the material extrusion rate through the nozzle (material weight/time) constant during at least part of the printing stage by maintaining the force constant.

Therefore, in embodiments the fused deposition modeling 3D printer may comprise a control system functionally coupled to one or more force-related parameter sensors.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some general aspects of the 3D printer; and

FIGS. 2a-2e schematically depict some aspects of the method and/or apparatus as defined herein.

The schematic drawings are not necessarily to scale.

### DETAILED DESCRIPTION OF THE EMBODIMENTS

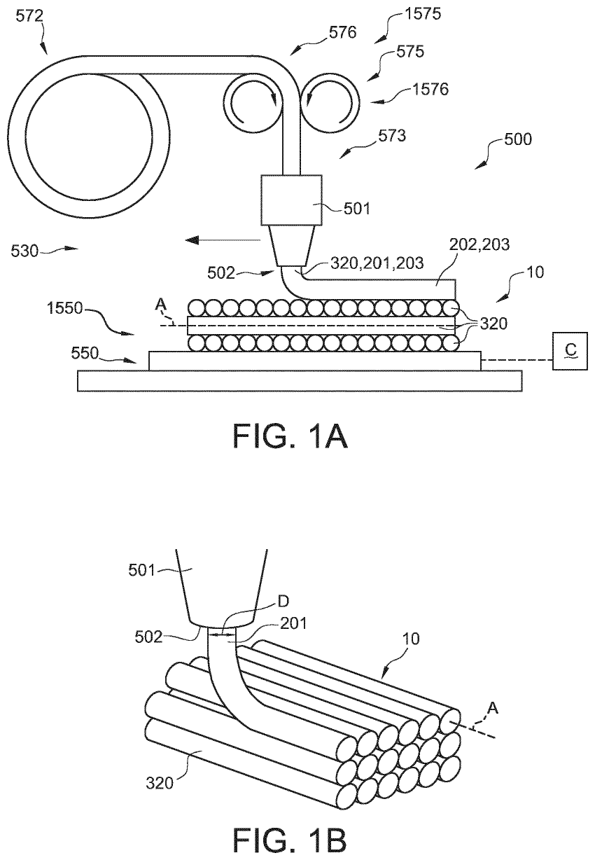

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. The 3D printing stage unit (530) comprises the printer head (501) and the printer nozzle (502). Here, only the printer head for providing 3D printed material, such as a FDM 3D printer head is schematically depicted. Reference 501 indicates the printer head. The 3D printer of the present invention may especially include a plurality of printer heads, though other embodiments are also possible. Reference 502 indicates a printer nozzle. The 3D printer of the present invention may especially include a plurality of printer nozzles, though other embodiments are also possible. Reference 320 indicates a filament of printable 3D printable material (such as indicated above). For the sake of clarity, not all features of the 3D printer have been depicted, only those that are of especial relevance for the present invention (see further also below).

The 3D printer 500 is configured to generate a 3D item 10 by depositing on a receiver item 550, which may in embodiments at least temporarily be cooled, a plurality of filaments 320 wherein each filament 20 comprises 3D printable material, such as having a melting point Tₘ. The 3D printer 500 is configured to heat the filament material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 (thus) includes a liquefier or heater. Reference 201 indicates printable material. When deposited, this material is indicated as (3D) printed material, which is indicated with reference 202.

Reference 572 indicates a spool or roller with material, especially in the form of a wire. The 3D printer 500 transforms this in a filament or fiber 320 on the receiver item or on already deposited printed material. In general, the diameter of the filament downstream of the nozzle is reduced relative to the diameter of the filament upstream of the printer head. Hence, the printer nozzle is sometimes (also) indicated as extruder nozzle. Arranging filament by filament and filament on filament, a 3D item 10 may be formed. Reference 575 indicates the filament providing device, which here amongst others include the spool or roller and the driver wheels, indicated with reference 576.

Reference A indicates a longitudinal axis or filament axis.

Reference C schematically depicts a control system, such as especially a temperature control system configured to control the temperature of the receiver item 550. The control system C may include a heater which is able to heat the receiver item 550 to at least a temperature of 50° C., but especially up to a range of about 350° C., such as at least 200° C.

FIG. 1a also schematically depicts an applicator 1575 configured to provide the filament 320 to the printer nozzle 502, wherein the applicator comprises a rotational element 1576 for transporting the filament 320. Here, the rotating wheels may be used to transport the filament 320.

FIG. 1b schematically depicts in 3D in more detail the printing of the 3D item 10 under construction. Here, in this schematic drawing the ends of the filaments 320 in a single plane are not interconnected, though in reality this may in embodiments be the case.

FIG. 1b also schematically depicts the diameter, indicated with reference D, of a filament 320 just expelled from the printer nozzle 502.

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 320 comprising 3D printable material 201 to the first printer head 501, and optionally (c) a receiver item 550. In FIGS. 1a-1b, the first or second printable material or the first or second printed material are indicated with the general indications printable material 201 and printed material 202.

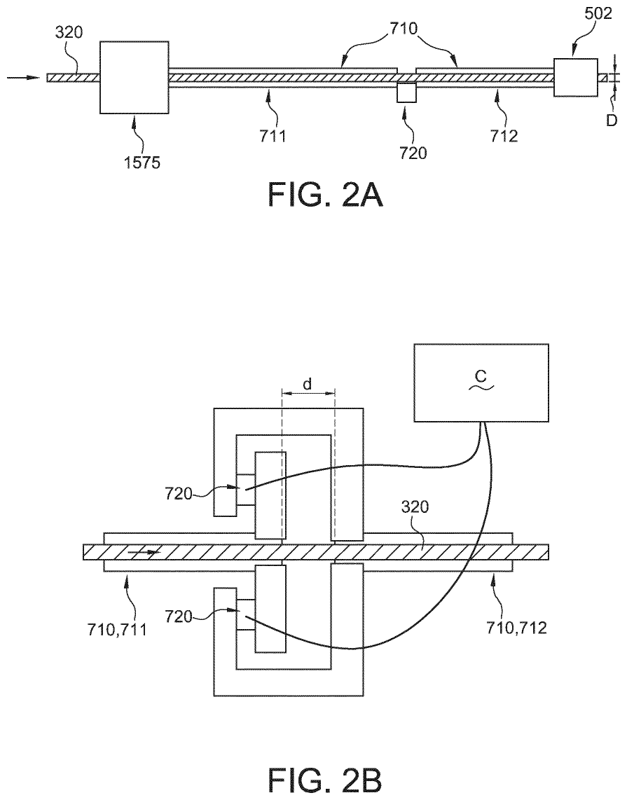

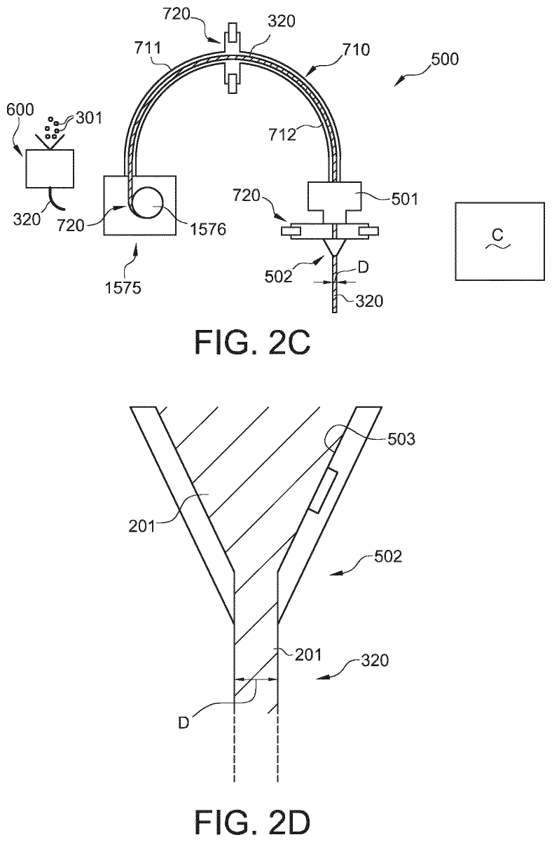

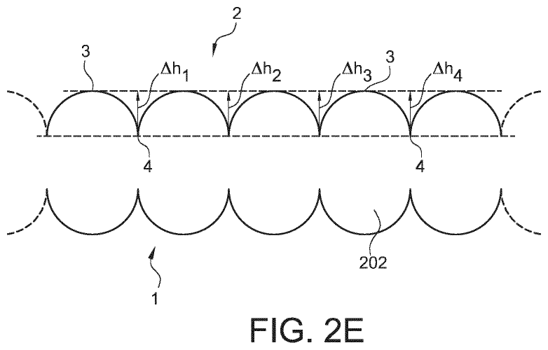

Force feedback mechanism can be used to keep the material flow rate (weight material per unit time) constant by measuring the force applied by the feeder motor (for example by measuring the current (as example of a force-related parameter that can be sensed). It is also possible to cut the guide tube and place a stress/strain gauge between the two parts for measuring the force applied during the extrusion as shown in FIG. 2a, and in more detail an embodiment is shown in FIG. 2b. Hence, these figures schematically show further a transport channel 710. The fused deposition modeling 3D printer (not further shown in detail, but see e.g. FIG. 1a) is configured to transport the filament 320 through the transport channel 710. The transport channel 710 comprises an upstream part 711 and a downstream part 712 which are associated to each other via a pressure sensor 720 for sensing the force-related parameter for controlling deposition of the 3D printable material 201. Based on the sensor signal, the control system C may control the force, for instance to maintain a constant diameter of the filament 320 escaping from the printer nozzle 502. For instance, the distance, indicated with reference d, between the upstream part 711 and the downstream part 712 may be used as force-related parameter. FIG. 2a also schematically shows an applicator 1575 configured to provide the filament 320 to the printer nozzle 502. When the force provided by the applicator is constant, the distance d will also be constant.

FIG. 2c schematically depict several positions where the pressure of force sensor 720 may be applied, such as at the applicator 1575, in an optional transport channel or guiding tube 710, but also at the nozzle 502. Note that the construction at the nozzle 502 is in essence not different from the sensor 720 at the top of the drawing. Hence, in embodiments the downstream part 712 comprises the printer nozzle 502. Note that FIG. 2c for the sake of illustrating the invention a plurality of possible position of the sensor 720 is depicted. Further, by way of example FIG. 2c also schematically depicts an (additional) extruder, indicated with reference 600. Particulate 3D printable material 201 is fed into the extruder 600 and extruded into the filament 320 of 3D printable material 201. This filament can be fed to the applicator 1575 (not shown in full detail). The other position where force may be measured, is within the nozzle, as further explained in FIG. 2d. The volume where the 3D printable thermoplastic polymer material is in the melt state (above Tg and Tm) is a very small volume e.g. typically lower than 100 mm³. Measuring pressure in such a small volume is rather difficult and/or inaccurate. Measuring the 3D printable thermoplastic polymer material in the solid state (input filament in the form of a cable) i.e. non-melt state is more straightforward and/or more accurate. FIG. 2c schematically depicts an embodiment of an applicator 1575 configured to provide the filament 320 to the printer nozzle 502, wherein the applicator 1575 comprises a rotational element 1576 for transporting the filament 320. In such embodiments, the method may comprise controlling a torque on the rotational element 1576 (for controlling the flow rate).

The sensor 720 may sense a force-related parameter at any position before the filament is heated to its glass temperature (Tg) and/or melting temperature (Tm) in the 3D printer 500.

The sensor 720 may sense a force related parameter at the position outside of the 3D printing stage unit 530. The 3D printing stage unit 530 may be flexibly arranged to a 3D printer 500 part such as for example the 3D printer frame or housing.

FIG. 2d schematically depicts an embodiment wherein the printer nozzle 502 comprises a printer nozzle wall 503 along which the 3D-printable material 201 is guided. The printer nozzle wall 503 comprises a pressure sensor 720 for sensing the force-related parameter for controlling extrusion of the 3D printable material 201.

FIG. 2e schematically depicts an embodiment of a 3D printed item 1 comprising 3D printed material 202. The 3D printed item 1 comprising a ribbed structure 2 comprising ridges 3 and valleys 4 defining height differences Δh between adjacent ridges and valleys. The different Δh's, herein indicates as Δh₁, Δh₂, Δh₃, Δh₄, etc., can be number averaged into Δh_{avg}. An average difference from an average height difference Δh_{avg} is equal to or less than 1%.

The term “plurality” refers to two or more.

The term “substantially” herein, such as “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for 3D printing a 3D item by means of fused deposition modeling using a fused deposition modeling 3D printer that comprises a liquefier or a heater configured to heat a 3D printable thermoplastic polymer material upstream of a printer nozzle, the method comprising providing the 3D printable thermoplastic polymer material to the printer nozzle, the 3D printable thermoplastic polymer material having a glass transition temperature (Tg) and/or a melting point (Tm), heating the 3D printable thermoplastic polymer material to a temperature of at least the glass transition temperature (Tg) or at least the melting temperature (Tm) of the 3D printable thermoplastic polymer material using the liquefier or the heater, using force for expelling the 3D printable thermoplastic polymer material through the printer nozzle, and depositing during a printing stage a filament comprising 3D printable thermoplastic polymer material via the printer nozzle, to provide the 3D item comprising 3D printed thermoplastic polymer material, wherein the method further comprises measuring the 3D printable thermoplastic polymer material in a solid state by sensing a force-related parameter by a sensor for controlling an extrusion rate of the 3D printable thermoplastic polymer material from the printer nozzle, wherein the sensor is arranged to sense the force-related parameter at a position upstream of the liquefier or the heater.

2. The method according to claim 1 using the fused deposition modeling 3D printer that comprises a 3D printing stage unit comprising a printer head and the printer nozzle, wherein the method comprising providing 3D printable thermoplastic polymer material by an applicator via a transport channel or a guiding tube to the liquefier or the heater and then to the printer nozzle, wherein the sensor is applied at at least one of the following positions:
(i) at the applicator,
(ii) at the transport channel or guiding tube,
(iii) at a flexible coupling element arranged between the printer nozzle and the printer head, wherein the printer nozzle is movably associated with the printer head.

3. The method according to claim 1, wherein the method comprises sensing the force-related parameter for controlling the extrusion rate of the filament, and wherein the method comprises comprising sensing the force-related parameter for maintaining the extrusion rate of the filament constant during at least part of the printing stage.

4. The method according to claim 1, wherein the method comprises providing the filament to the printer nozzle with an applicator configured to provide the filament to the printer nozzle, wherein the applicator comprises a rotational element for transporting the filament, and wherein the method comprises controlling a torque applied by to rotational element for controlling the extrusion rate of the 3D printable material.

5. The method according to claim 1, wherein the method comprises transporting the filament through a transport channel, wherein the transport channel comprises an upstream part and a downstream part which are associated to each other via a pressure sensor for sensing the force-related parameter for controlling extrusion rate of the 3D printable material.

6. The method according to claim 5, wherein the downstream part comprises the printer nozzle.

7. The method according to claim 1, wherein the printer nozzle comprises a printer nozzle wall along which the 3D-printable material is guided, and wherein the printer nozzle wall comprises a pressure sensor for sensing the force-related parameter for controlling extrusion rate of the 3D printable material.

8. The method according to claim 6, wherein the method further comprises processing particulate 3D printable material into the filament for introduction into the printer head.

9. A fused deposition modeling 3D printer for using a method according to claim 1, wherein the fused deposition modeling 3D printer comprises (a) a printer head comprising a printer nozzle, and (b) a 3D printable material providing device configured to provide 3D printable material to the printer head, wherein the fused deposition modeling 3D printer is configured to deposit during a printing stage a filament comprising 3D printable material via the printer nozzle using force for expelling the 3D printable material through the printer nozzle, and wherein the fused deposition modeling 3D printer further comprises (c) a pressure sensor configured for measuring the 3D printable material in a solid state by sensing a force-related parameter for controlling extrusion rate of the 3D printable material from the printer nozzle, the sensor being arranged to sense the force-related parameter at a position upstream of the liquefier or the heater.

10. The fused deposition modeling 3D printer according to claim 9, further comprising an applicator configured to provide the filament to the printer nozzle, wherein the applicator comprises a rotational element for transporting the filament, and wherein the method comprises controlling a torque on the rotational element.

11. The fused deposition modeling 3D printer according to claim 9, further comprising a transport channel, wherein the fused deposition modeling 3D printer is configured to transport the filament through the transport channel, wherein the transport channel comprises an upstream part and a downstream part which are associated to each other via a pressure sensor for sensing the force-related parameter for controlling extrusion rate of the 3D printable material.

12. The fused deposition modeling 3D printer according to claim 11, wherein the downstream part comprises the printer nozzle.

13. The fused deposition modeling 3D printer according to claim 9, wherein the printer nozzle comprises a printer nozzle wall along which the filament is to be guided, and wherein the printer nozzle wall comprises a pressure sensor for sensing the force-related parameter for controlling extrusion rate of the 3D printable material.

14. The fused deposition modeling 3D printer according to claim 9, further comprising an extruder for converting particulate 3D printable material into a filament for introduction to the printer head.

15. The fused deposition modeling 3D printer according to claim 9, wherein the fused deposition modeling 3D printer is configured to maintain the extrusion rate of the filament constant during at least part of the printing stage by maintaining the force constant.
